(19) United States
(12) Patent Application Publication
(10) Pub. No.: US 2018/0148630 A1
(43) Pub. Date: May 31, 2018

(54) WELL CEMENTING COMPOSITIONS AND METHODS

(71) Applicant: SCHLUMBERGER TECHNOLOGY CORPORATION, Sugar Land, TX (US)

(72) Inventors: Andrey Vladimirovich YAKOVLEV, Houston, TX (US); Mohan Kanaka Raju PANGA, Sugar Land, TX (US); Valerie Gisele Helene LAFITTE, Sugar Land, TX (US)

(21) Appl. No.: 15/575,408

(22) PCT Filed: May 19, 2016
(86) PCT No.: PCT/US2016/033161

§ 371 Date: Nov. 20, 2017

Related U.S. Application Data
(60) Provisional application No. 62/164,196, filed on May 20, 2015.

(51) Int. Cl. C09K 8/487; C04B 28/04; C04B 24/26; C04B 24/16; C04B 24/38; C04B 14/36; C09K 8/42; C09K 8/48; E21B 33/138; E21B 21/00

(52) U.S. Cl. CPC C09K 8/487; C04B 28/04; C04B 24/2611; C04B 24/166; C04B 24/383; C04B 2103/46; C09K 8/424; C09K 8/48; E21B 33/138; E21B 21/003; C04B 14/368

(57) ABSTRACT

Cement slurry compositions comprising water, an inorganic cement and additive comprising nanocrystalline cellulose, microcrystalline cellulose, cellulose fibrils, or bacterial nanocellulose or combinations thereof have reduced fluid loss values. Such compositions may be prepared and placed in subterranean wells. The compositions are suitable for use during primary cementing or remedial cementing operations.

### CROSS-REFERENCE TO RELATED APPLICATION(S)

This application claims the benefit of U.S. Provisional Application Ser. No. 62/164,196 filed May 20, 2015 entitled “Well Cementing Compositions and Methods” to Panga et al. (Attorney Docket No. IS15.0361-US-PSP), the disclosure of the provisional application is incorporated by reference herein in its entirety.

### BACKGROUND

The statements in this section merely provide background information related to the present disclosure and may not constitute prior art.

The present disclosure broadly relates to compositions and methods for reducing the fluid loss of cement slurries, drilling fluids, spacers and washes.

When cement slurries are pumped against a porous medium such as a subterranean rock formation, the pressure differential between the slurry and the formation may lead to filtration. The aqueous phase of the cement slurry escapes into the formation, leaving the solids behind. Depending on the relative importance of erosional forces during fluid flow and sticking forces due to filtration, the solids can form an external filter cake along the formation wall or remain suspended in the cement slurry. A small amount of solids may also enter the larger pores in the formation, creating an internal filter cake.

During primary cementing, the cement slurry flows along the formation wall, and a dynamic tangential filtration process takes place. In most cases, drilling mud, chemical washes and spacers have encountered the formation before the cement slurry; thus, some filtration into the formation has already occurred. Later, when pumping ceases, a static filtration period takes place. During remedial cementing, the filtration is largely static.

Insufficient fluid-loss control may be responsible for primary cementing failures owing to excessive increases in slurry viscosity during placement, annular bridging, or accelerated pressure declines during the waiting-on-cement (WOC) period. In addition, invasion of cement filtrate into the formation can cause damage and reduce production.

The American Petroleum Institute (API) fluid-loss value of a neat cement slurry generally exceeds 1,500 mL/30 min. However, in some circumstances, an API fluid-loss value lower than 50 mL/30 min may be needed to maintain adequate slurry performance. To accomplish such a fluid-loss reduction, materials known as fluid-loss control agents are usually included in the slurry design.

Two principal classes of fluid-loss additives exist: finely divided particulate materials and water-soluble polymers. Particulate additives include bentonite, micro silica, latexes and microgels. Water-soluble long-chain polymers include cellulose derivatives such as hydroxyethylcellulose (HEC) and carboxymethylhydroxyethylcellulose (CMHEC), galactomannans, polyvinylpyrrolidone, polyacrylamide, polyethylene imine (PEI) and polymers based on 2-acrylamido-2-methyl propane sulfonic acid (AMPS). Without wishing to be held to any particular theory, particulate fluid-loss additives are generally thought to become lodged in formation-rock or filter-cake pores, thereby lowering the formation-rock or filter-cake permeability and hindering escape of the aqueous phase from the slurry. Water soluble polymers are generally thought to viscosify the aqueous phase to hinder filtration, or form impermeable membranes that act as fluid-flow barriers or both.

### SUMMARY

The present disclosure reveals compositions and methods by which the fluid loss of cement slurriesmay be lowered. Lowering the fluid loss from drilling fluids and preflushes (chemical washes or spacers) is also envisioned.

In an aspect, embodiments relate to compositions that comprise water, an inorganic cement and an additive that comprises nanocrystalline cellulose, microcrystalline cellulose, cellulose fibrils, or bacterial nanocellulose or a combination thereof.

In a further aspect, embodiments relate to methods for reducing the fluid loss value of a cement slurry. A cement slurry is prepared that comprises water, an inorganic cement and an additive that comprises nanocrystalline cellulose, microcrystalline cellulose, cellulose fibrils, or bacterial nanocellulose or a combination thereof. The cement slurry is placed adjacent to a porous medium, and pressure is applied to the slurry.

In yet a further aspect, embodiments relate to methods for cementing a subterranean well. A cement slurry is prepared that comprises water, an inorganic cement and an additive that comprises nanocrystalline cellulose, microcrystalline cellulose, cellulose fibrils, or bacterial nanocellulose or a combination thereof. The cement slurry is placed in the well.

### BRIEF DESCRIPTION OF THE DRAWINGS

FIG. 1 shows the results of fluid-loss tests performed with cement slurries containing various nanocellulose products.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

Applicant has determined that materials based on nanocellulose are effective fluid-loss control agents.

Nanocellulose may refer to at least three different types of nanocellulose materials, which vary depending on the fabrication method and the source of the natural fibers. These three types of nanocellulose materials are called nanocrystalline cellulose (NCC), microfibrillated cellulose (WC) or nanofibrillated cellulose, and bacterial cellulose (BC), which are described below. Additional details regarding these materials are described in U.S. Pat. Nos. 4,341,807, 4,374,702, 4,378,381, 4,452,721, 4,452,722, 4,464,287, 4,483,743, 4,487,634 and 4,500,546, the disclosures of each of which are incorporated by reference herein in their entirety.

Nanocellulose materials have a repetitive unit of β-1,4 linked D glucose units, as seen in the following chemical structure:

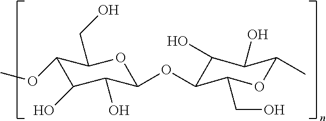

The integer values for the variable n relate to the length of the nanocellulose chains, which generally depends on the source of the cellulose and even the part of the plant containing the cellulose material.

In some embodiments, n may be an integer of from about 100 to about 10,000, from about 1,000 to about 10,000, or from about 1,000 to about 5,000. In other embodiments, n may be an integer of from about 5 to about 100. In other embodiments, n may be an integer of from about 5000 to about 10,000. In embodiments, the nanocellulose chains may have an average diameter of from about 1 nm to about 1000 nm, such as from about 10 nm to about 500 nm or 50 nm to about 100 nm.

Nanocrystalline cellulose (NCC), also referred to as cellulose nanocrystals, cellulose whiskers, or cellulose rod-like nanocrystals, or crystalline nanocellulose (CNC) can be obtained from cellulose fibers. However, cellulose nanocrystals may have different shapes besides rods. Examples of these shapes include any nanocrystal in the shape of a 4-8 sided polygon, such as, a rectangle, hexagon or octagon. NCCs are generally made via the hydrolysis of cellulose fibers from various sources such as cotton, wood, wheat straw and cellulose from algae and bacteria. These cellulose fibers are characterized in having two distinct regions, an amorphous region and a crystalline region. In embodiments, NCC can be prepared through acid hydrolysis of the amorphous regions of cellulose fibers that have a lower resistance to acid attack as compared to the crystalline regions of cellulose fibers. Consequently, NCC particles with “rod-like” shapes (herein after referred to as “rod-like nanocrystalline cellulose particles” or more simply “NCC particles”) having a crystalline structure are produced. In embodiments, the hydrolysis process may be conducted under mild conditions such that the process does not result in any considerable degradation or decomposition rod-like crystalline portion of the cellulose.

In some embodiments, NCC can be prepared through acid hydrolysis of the amorphous and disordered paracrystalline regions of cellulose fibers that have a lower resistance to acid attack as compared to the crystalline regions of cellulose fibers. During the hydrolysis reaction, the amorphous and disordered paracrystalline regions of the cellulose fibers are hydrolyzed, resulting in removal of microfibrils at the defects. This process also results in rod-like nanocrystalline cellulose particles or more simply “NCC particles” having a crystalline structure. In embodiments, the hydrolysis process may be conducted under mild conditions such that the process does not result in any considerable degradation or decomposition rod-like crystalline portion of the cellulose.

Consequently, NCC particles with “rod-like” shapes (herein after referred to as “rod-like nanocrystalline cellulose particles” or more simply “NCC particles”) having a crystalline structure are produced.

The NCC particles may be exceptionally tough, with a strong axial Young's modulus (150 GPa) and may have a morphology and crystallinity similar to the original cellulose fibers (except without the presence of the amorphous). In some embodiments, the degree of crystallinity can vary from about 50% to about 100%, such as from about 65% to about 85%, or about 70% to about 80% by weight. In some embodiments, the degree of crystallinity is from about 85% to about 100% such as from about 88% to about 95% by weight.

In embodiments, the NCC particles may have a length of from about 50 to about 500 nm, such as from about 75 to about 300 nm, or from about 90 to about 150 nm. In embodiments, the diameter of the NCC particles may further have a diameter of from about 2 to about 500 nm, such as from about 2 to about 100 nm, or from about 2 to about 10 nm. In embodiments, the NCC particles may have an aspect ratio (length:diameter) of from about 10 to about 100, such as from about 25 to about 100, or from about 50 to about 75.

Techniques that are commonly used to determine NCC particle size are scanning electron microscopy (SEM), transmission electron microscopy (TEM) and/or atomic force microscopy (AFM). Wide angle X-ray diffraction (WAXD) may be used to determine the degree of crystallinity.

In some embodiments, the NCCs or NCC particles may have a surface that is closely packed with hydroxyl groups, which allows for chemical modifications to be performed on their surfaces. In embodiments, some of the hydroxyl groups of the NCC or NCC particles may have been modified or converted prior to, during, and/or after introduction into the wellbore, such as to a sulfate ester group, during acid digestion. In some embodiments, some of the hydroxyl groups of the NCC or NCC particles surface may have been modified or converted to be carboxylated.

In embodiments, the choice of the method to prepare the NCCs or NCC particles (and thus the resultant functional groups present on the surface of the NCCs or NCC particles) may be used to tailor the specific properties of the fluids comprising the NCCs or NCC particles. For example, fluids comprising NCCs or NCC particles may display a thixotropic behavior or antithixotropic behavior, or no time-dependent viscosity. For instance, fluids incorporating hydrochloric acid-treated NCCs or NCC particles may possess thixotropic behavior at concentrations above 0.5% (w/v), and antithixotropic behavior at concentrations below 0.3% (w/v), whereas fluids incorporating sulfuric acid treated NCCs or NCC particles may show no time-dependent viscosity.

In embodiments, the NCC or NCC particles may be functionalized to form a functionalized NCC particle, such as a functionalized NCC particle in which the outer circumference of the nanocrystalline cellulose has been functionalized with various surface modifiers, functional groups, species and/or molecules. For example, such chemical functionalizations and/or modifications may be conducted to introduce stable negative or positive electrostatic charges on the surface of NCCs or NCC particles. Introducing negative or positive electrostatic charges on the surface of NCCs or NCC particles may allow for better dispersion in the desired solvent or medium.

In embodiments, the NCC or NCC particles may be surface-only functionalized NCC or NCC particles in which the outer circumference of the NCC or NCC particle has been functionalized with various surface modifiers, functional groups, species and/or molecules. In embodiments, the surface of the NCC or NCC particles may be modified, such as by removing any charged surface moieties under conditions employed for surface functionalization, in order to minimize flocculation of the NCC or NCC particles when dispersed in a solvent, such as an aqueous solvent.

Modification, such as surface-only modification, of the NCC or NCC particles, may be performed by a variety of methods, including, for example, esterification, etherification, acetylation, silylation, oxidation, grafting polymers on the surface, functionalization with various chemical moieties (such as with a hydrophobic group to improve compatibility with hydrocarbons and/or oil), and noncovalent surface modification, including the use of adsorbing surfactants and polymer coating, as desired. In embodiments, the surface functionalization process may be conducted under mild conditions such that the process does not result in any considerable degradation or decomposition rod-like nanocrystalline particles.

In embodiments, modification (such as surface-only modification) by grafting polymerization techniques may preserve the particle shape of the NCC or NCC particles. For example, the shape may be preserved by selecting a low molecular weight polymer, such as a polymer with a molecular weight not exceeding about 100,000 Daltons, or not exceeding about 50,000 Daltons, to be grafted onto the NCC particle surface.

In embodiments, chemical modifications may involve electrophiles that are site-specific when reacting with hydroxyl groups on NCC or NCC particle surfaces. For instance, such electrophiles may be represented by a general formula such as, for example, RX, where “X” is a leaving group that may include a halogen, tosylate, mesylate, alkoxide, hydroxide or the like, and “R” may contain alkyl, silane, amine, ether, ester groups and the like. In embodiments, surface functionalization with such electrophiles may be performed in a manner that does not decrease the size or the strength of the NCC or NCC particle.

In some embodiments, the NCC or NCC particle surfaces may have a percent surface functionalization of about 5 to about 90 percent, such as from of about 25 to about 75 percent, and or of about 40 to about 60 percent. In some embodiments, about 5 to about 90 percent of the hydroxyl groups on NCC or NCC particle surfaces may be chemically modified, 25 to about 75 percent of the hydroxyl groups on NCC or NCC particle surfaces may be chemically modified, or 40 to about 60 percent of the hydroxyl groups on NCC or NCC particle surfaces may be chemically modified.

Fourier Transform Infrared (FT-IR) and Raman spectroscopies and/or other known methods may be used to assess percent surface functionalization, such as via investigation of vibrational modes and functional groups present on the NCC or NCC particles. Additionally, analysis of the local chemical composition of the cellulose, NCC or NCC particles may be carried out using energy-dispersive X-ray spectroscopy (EDS). The bulk chemical composition can be determined by elemental analysis (EA). Zeta potential measurements can be used to determine the surface charge and density. Thermal gravimetric analysis (TGA) and differential scanning calorimetry (DSC) can be employed to understand changes in heat capacity and thermal stability.

Micro Fibrillated Cellulose (MFC), Nano Fibrillated Cellulose (NFC) or nanofibrils (also known as cellulose nano- and microfibrils [CNF]), is a form of nanocellulose derived from wood products, sugar beet, agricultural raw materials or waste products. In MFC (or CNF), the individual microfibrils have been incompletely or totally detached from each other. For example, the microfibrillated cellulose material has an average diameter of from about 5 nm to about 500 nm, from about 5 nm to about 250 nm, or from about 10 nm to about 100 nm. In some embodiments, the microfibrillated cellulose material may have an average diameter of from about 10 nm to about 60 nm. Furthermore, in MFC (or CNF), the length may be up to 1 μm, such as from about 500 nm to about 1 μm, or from about 750 nm to about 1 μm. The ratio of length (L) to diameter (d) of the MFC (or CNF) may be from about 50 to about 150, such as from about 75 to about 150, or from about 100 to about 150. Nanofibrillated cellulose (NFC) may have a diameter between about 4 nm and 20 nm, and a length between about 500 nm and 2 μm.

One common way to produce MFC (or CNF) is the delamination of wood pulp by mechanical pressure before and/or after chemical or enzymatic treatment. Additional methods include grinding, homogenizing, intensification, hydrolysis/electrospinning and ionic liquids. Mechanical treatment of cellulosic fibers is very energy consuming and this has been a major impediment for commercial success. Additional manufacturing examples of MFC are described in WO 2007/091942, WO 2011/051882, U.S. Pat. No. 7,381,294 and U.S. Patent Application Pub. No. 2011/0036522, each of which is incorporated by reference herein in their entirety.

MFC may be similar in diameter to the NCC particle, but MFC is more flexible because NCC particles have a very high crystalline content (which limits flexibility). For example, in contrast to the high crystalline content of NCC particles, which may be homogeneously distributed or constant throughout the entire NCC particle, MFCs contain distinct amorphous regions, such as amorphous regions that alternate with crystalline regions, or amorphous regions in which crystalline regions are interspersed. Additionally, MFCs possess little order on the nanometer scale, whereas NCC and/or NCC particles are highly ordered. Furthermore, the crystallinity of MFCs may approach 50%, whereas the crystallinity of NCCs is higher and will depend on the method of production. MFC and NFC may be surface functionalized during the manufacturing process, typically through TEMPO oxidation conferring some carboxylate groups. They may also be functionalized after production because the surface contains reactive hydroxyl groups. The nature of the surface may therefore be altered such that it may be more compatible with its environment.

Bacterial nanocellulose is a material obtained via a bacterial synthesis from low molecular weight sugar and alcohol for instance. The diameter of this nanocellulose is found to be about 20-100 nm in general. Characteristics of cellulose producing bacteria and agitated culture conditions are described in U.S. Pat. No. 4,863,565, the disclosure of which is incorporated by reference herein in its entirety. Bacterial nanocellulose particles are microfibrils secreted by various bacteria that have been separated from the bacterial bodies and growth medium. The resulting microfibrils are microns in length, have a large aspect ratio (higher than 50) with a morphology depending on the specific bacteria and culturing conditions.

In an aspect, embodiments relate to compositions that comprise water, an inorganic cement and an additive that comprises nanocrystalline cellulose, microcrystalline cellulose, cellulose fibrils, or bacterial nanocellulose or a combination thereof.

In a further aspect, embodiments relate to methods for reducing the fluid loss value of a cement slurry. A cement slurry is prepared that comprises water, an inorganic cement and an additive that comprises nanocrystalline cellulose, microcrystalline cellulose, cellulose fibrils, or bacterial nanocellulose or a combination thereof. The cement slurry is placed adjacent to a porous medium, and pressure is applied to the slurry. The porous medium may be a rock.

In yet a further aspect, embodiments relate to methods for cementing a subterranean well. A cement slurry is prepared that comprises water, an inorganic cement and an additive that comprises nanocrystalline cellulose, microcrystalline cellulose, cellulose fibrils, or bacterial nanocellulose or a combination thereof. The cement slurry is placed in the well. The slurry placement may occur during a primary cementing operation or a remedial cementing operation.

In each of the embodiments, the cellulose fibrils may be microfibrils, nanofibrils or both.

For each of the embodiments, the additive may be present at a concentration between 0.001% and 5% percent by weight of the cement. Or, the additive may be present at a concentration between 0.05% and 0.5% by weight of the cement. Or, the additive may be present at a concentration between 0.1% and 0.3% by weight of the cement.

For each of the embodiments, the nanocrystalline cellulose, microcrystalline cellulose, cellulose fibrils, or bacterial nanocellulose may have diameters between 4 nanometers and 20 microns. Or, the diameters may be between 10 nanometers and 10 microns. Or, the diameters may be between 100 nanometers and 2 microns.

For each of the embodiments, the fibrils, nanocellulose particles or bacterial nanocellulose may have lengths between 50 nanometers and 3 millimeters. Or, the lengths may be between 100 nanometers and 350 microns. Or, the lengths may be between 5 and 10 microns.

For each of the embodiments, the cement may comprise portland cement, calcium aluminate cement, fly ash, blast furnace slag, lime/silica blends or zeolites or combinations thereof.

In embodiments, if the composition described herein deployed as a spacer composition, additional materials, such as, for example, surfactants and weighting agents may be included.

The spacer fluid composition also contains a weighting agent. The weighting agent provides the spacer fluid with the proper density profile to separate the fluids from one another. The proper weighing agent of the spacer fluid composition relative to each fluid ensures that the spacer fluid composition does not “invert” with one of the other fluids present in the well bore. Weighting agents include sand, barite (barium sulfate), hematite, calcite, fly ash, silica sand, ilmenite, manganese oxide, manganese tetraoxide, zink oxide, zirconium oxide, iron oxide and fly ash.

The weighing agent is present in the spacer fluid composition a range of from about 50 lb/bbl to about 700 lb/bbl, such as, for example, from about 100 lb/bbl to about 500 lb/bbl and from about 200 lb/bbl to about 400 lb/bbl of base aqueous fluid. One of ordinary′skill in the art recognizes the appropriate amount of weighing agent for the spacer fluid composition given the application circumstances and therefore understands that all values within the provided range are included.

The density profile of the spacer fluid composition relative to the other fluids is such that the spacer fluid composition has a similar or greater density than the displaced fluid but has a lower density than the displacing fluid. In some instances, the displaced fluid is the oil-based mud and the displacing fluid is the water-based cement slurry. The higher density spacer fluid composition pushes gelled and solid remnants of the displaced fluid away from the well bore wall and fluid conduit exteriors.

The spacer fluid composition has a density in the range of from about 70 to about 150 pounds per cubic foot. One of ordinary skill in the art recognizes that spacer fluids can have a density at any value within this range given the application circumstances and therefore understands that all values within the provided range are included.

Surfactant

The spacer fluid composition contains a surfactant. Examples of surfactants include non-ionic surfactants or anionic surfactants or combinations thereof. The non-ionic surfactant is a surface-active agent that does not dissociate into ions in aqueous solutions, unlike an anionic surfactant, which has a negative charge, and a cationic surfactant, which has a positive charge, in an aqueous solution. The non-ionic surfactant is compatible with both ionic and non-ionic components of the spacer fluid composition because it is charge-neutral. Hydrophilic functional groups present on non-ionic surfactants can include alcohols, phenols, ethers, esters and amides. Non-ionic surfactants are widely used as detergents, have good solvency in aqueous solutions, exhibit low foam properties and are chemical stable.

An embodiment of the spacer fluid composition includes a non-ionic surfactant that is an ethoxylated alcohol. Some refer to ethoxylated alcohols as “polyoxyalkylene glycol alkyl ethers”, which describes the reaction product of an alcohol (alkyl) with the degree of ring-opening oligomerization that the alkyloxide undergoes to form the ethoxylated reaction product (polyoxyalkylene glycol). Both sections of the resultant molecule join through an ether link. The non-ionic surfactant in some instances is an ethoxylated alcohol.

Alcohols useful to form the alkyl portion of the ethoxylated alcohol include normal, iso-, and cyclo-aliphatic alcohols. Example alcohols include fatty alcohols and long-chained alcohols with slight branching having a carbon count from about 3 to about 30 carbons, isopropanol, n-butanol and cyclohexanol. Primary and secondary alcohols are included.

The degree of ethoxylation for the ethoxylated alcohol depends on several factors. The degree of ethoxylation, which refers to the number of ethylene oxides used to form the polyoxyethylene glycol portion of the surfactant, can range from about 2 to about 50 for the ethoxylated alcohol. Considerations include the carbon count of the alcohol, the desired overall solubility of the surfactant in the spacer fluid, foaming/emulsion effects of the surfactant-hydrocarbon complex, and the balance between hydrophobic effects of the alkyl portion of the surfactant to the hydrophilic effects of the polyethoxylated portion of the surfactant. For fatty alcohols, the degree of ethoyxlation is typically between about 4 and about 40 depending on the end-use of the ethoxylated fatty alcohol.

Other useful non-ionic surfactants for the spacer fluid composition include ethoxylated phenols and ethoxylated alkyl phenols. The ether link between the ethoxylated portion and the phenol/alkyl. phenol portion of the surfactant forms from reaction of the alcohol moiety on the phenol. For alkyl phenols; an alkyl functional group extends from the phenol that contributes to the hydrophobic properties of the surfactant. Example alkyl. phenols include dodecylphenols, nonylphenols, octylphenols. The degree of ethoxylation ranges from about 4 to about 50.

Non-ionic surfactants for the spacer fluid composition also include various epoxide block co-polymerizations of ethylene oxide with other alkoxylates, including components formed from propylene oxide and butylene oxide. The alkoxylates are capable of foaming co-, ter-, and higher order macromolecules and polymers. For example, a polypropylene oxide glycol (hydrophobic portion) allowed to react with several ethylene oxides can faun an ABA configuration EO/PO/EO polymeric surfactant. These alkoxylated tri-block macromolecules are also known as “poloxamers”.

Examples of other useful non-ionic surfactants for the spacer fluid composition include fatty alcohols; alkypolyglucosides; alkoxylated oils and fats, including ethoxylated lanolin, castor oil; and soy bean oil; fatty amine ethoxylates; alkanolamides, including monoalkanolamides, dialkanolamides, and esteramides; alkoxylated alkanolamides, including polyethoxylated monoalkanolamides and polyethoxylated dialkanolamide; alkoxylated fatty acid monoesters and diesters; alkoxylated glycols and glycol esters, including ethoxylated glycol monoester and ethoxylated glycerol monoester; alkoxylated amines, including mono-, di-, and triethanolamine; ethoxylated polysiloxanes and silicones; ethoxylated thiols, including ethoxylated terdodecyl mercaptan; and ethoxylated imidazoles.

To assist in incorporating the non-ionic surfactant in an aqueous medium, the non-ionic surfactant can also include other components in various proportions, including alcohols, refined crude oil fractions and polar hydrocarbons. For example, isopropyl alcohol, naphthalene and heavy aromatic petroleum naphtha are useful for delivering the non-ionic surfactant into an aqueous medium.

The non-ionic surfactant is present in the spacer fluid composition by volume per barrel of base aqueous solution in the spacer fluid composition.

Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, alkyl ether sulfates, linear and branched ether sulfates, and mixtures thereof.

The surfactant may be present in the spacer fluid composition in a range of from about 0.5 gallons to about 5 gallons per barrel of the spacer fluid composition.

Additional materials may be included in the spacer fluid composition such as, for example, dispersants and retarders. Examples of dispersants include lignosulfonates, hydroxycarboxylic acids such as citric acid, tartaric acid, salicylic acid, gluconic acid, and glucoheptonic acid, phosphonic acids and their salts, sugars and polysaccharides, inorganic salts, acids and oxides. The dispersant or retarder is present in the spacer fluid composition in a range of from about 0.01 gallons to about 5 gallons per barrel of spacer or from 0.01 to 5% per weight of base aqueous fluid.

For each of the embodiments, the cement slurry viscosity may be lower than 300 cP at a shear rate of 511 s⁻¹.

The following examples serve to further illustrate the disclosure.

### Examples

Several cement slurries were prepared from Class H portland cement with the following base composition (Table 1). One sack of cement weighs 94 lb (42.7 kg). The cement slurry density was 16.2 lbm/gal (1940 kg/m³).

TABLE 1
Base cement slurry composition.

| | | |
|---|---|---|
| Fresh Water | 4.2 | gal/sack |
| | (37 | L/tonne) |
| polyproplyene | 0.02 | gal/sack |
| glycol | (1.78 | L/tonne) |
| polymelamine | 0.1 | gal/sack |
| sulfonate | (8.89 | L/tonne) |

Cellulose nano fibrils (CNF) and crystalline nanocellulose (CNC) particles were mixed with the base composition. The list of materials is given in Table 2.

TABLE 2
Nanocellulose additives.

| | | |
|---|---|---|
| CNC | Anionic | Length: 92 nm |
| | | Diameter: 6 nm |
| CNF1 | Non-ionic | Length: 1 μm-3 mm, |
| | | Diameter: 5 nm-20 μm |
| CNF2 | Non-ionic | Length: 1 μm-3 mm, |
| | | Diameter: 5 nm-20 μm |
| CNF3 | Non-ionic | Length: 250-350 μm, |
| | | Diameter: 10 nm-10 μm |
| CNF4 | Anionic | Length: 5-10 μm, |
| | | Diameter: 100 nm-2 μm |
| CNF5 | Anionic | Length: 500-1000 nm |
| | | Diameter: 4 nm |

Seven fluid-loss tests were performed. A first test was performed with the base cement composition of Table 1. The other six tests were performed with slurries composed of the base composition plus 0.2% by weight of cement (BWOC) of one of the nanocellulose materials described in Table 2. Before addition to the base slurry, the nanocellulose materials were predispersed in distilled water.

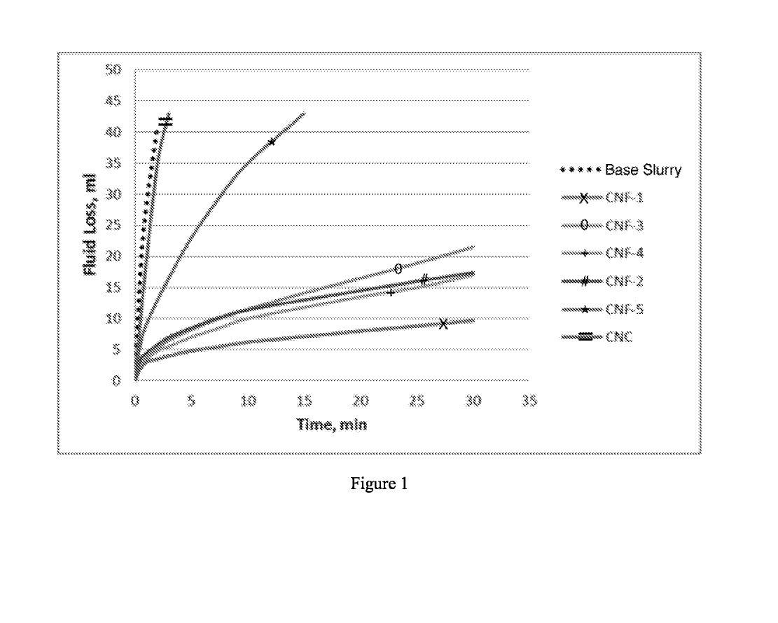

According to the API procedure, the slurries were prepared in a Waring blender. The nanocellulose materials were added during the period when the blender speed was 4000 RPM. The slurry was then conditioned in an atmospheric consistometer for 20 minutes at 140° F. (60° C.) and poured into a preheated fluid loss cell at the same temperature. The fluid-loss test was then performed at a differential pressure of 500 psi (34.5 bars). The results are presented in FIG. 1.

Several spacer formulations containing CNC were prepared and fluid loss was measured (Table 3). In each case barite was used as a weighting agent and a surfactant was added to the fluid at concentration 1 gal/bbl. The density of spacers was 13.0 lbm/gal.

Spacers were prepared in a Waring blender by dispersing dry nanocellulose in water at 4000 RPM and adding a required amount of weighting agent (barite) to the final fluid. Each spacer was then conditioned in an atmospheric consistometer for 20 minutes at 185° F. and poured into a preheated fluid loss cell at the same temperature. The fluid-loss test was then performed at a differential pressure of 1000 psi. The resulted fluid volume filtered out of the spacer after 30 min was measured. API fluid loss was calculated as 2×V(filtrate) and presented in Table 3.

TABLE 3
API Fluid Loss for spacers with CNC

| | CNC concentration, | API Fluid Loss, ml |
|---|---|---|
| | % BWOW | 30 min@1000 psi |
| Spacer I | 2.0 | 80 |
| Spacer II | 3.0 | 52 |
| Spacer III | 4.0 | 40 |

Although various embodiments have been described with respect to enabling disclosures, it is to be understood that this document is not limited to the disclosed embodiments. Variations and modifications that would occur to one of skill in the art upon reading the specification are also within the scope of the disclosure, which is defined in the appended claims.

1. A composition, comprising:
(i) water;
(ii) an inorganic cement or a weighting agent; and
(iii) an additive comprising nanocrystalline cellulose, microcrystalline cellulose, cellulose fibrils, or bacterial nanocellulose or a combination thereof.

2. The composition of claim 1, wherein the cellulose fibrils are microfibrils or nanofibrils or both.

3. The composition of claim 1, wherein the additive is present at a concentration between 0.001% and 5% by weight of the cement.

4. The composition of claim 1, wherein the nanocrystalline cellulose, microcrystalline cellulose, cellulose fibrils, or bacterial nanocellulose or a combination thereof have diameters between 4 nanometers and 20 microns.

5. The composition of claim 1, wherein the nanocrystalline cellulose, microcrystalline cellulose, cellulose fibrils, or bacterial nanocellulose or a combination thereof have lengths between 50 nanometers and 3 millimeters.

6. The composition of claim 1, wherein the cement comprises portland cement, calcium aluminate cement, fly ash, blast furnace slag, lime/silica blends or zeolites or combinations thereof.

7. The composition of claim 1, wherein the composition is a spacer composition that further comprises a surfactant.

8. The composition of claim 7, wherein the cellulose additive is present at a concentration between 0.001% and 10% by weight of water.

9. The composition of claim 7, wherein the weighting agent is selected from the group consisting of barite, hematite, calcite, silica, manganese oxides or combinations thereof.

10. A method for reducing a fluid-loss value of a slurry composition, comprising:
(i) preparing the slurry composition, the slurry comprising water, an inorganic cement or a weighting agent and an additive that comprises nanocrystalline cellulose, microcrystalline cellulose, cellulose fibrils, or bacterial nanocellulose or a combination thereof;
(ii) placing the slurry composition adjacent to a porous medium; and
(iii) applying pressure to the slurry composition.

11. The method of claim 10, wherein the cellulose fibrils are microfibrils or nanofibrils or both.

12. The method of claim 10, wherein the additive is present at a concentration between 0.001% and 5% by weight of the cement.

13. The method of claim 10, wherein the nanocrystalline cellulose, microcrystalline cellulose, cellulose fibrils, or bacterial nanocellulose have diameters between 4 nanometers and 20 microns.

14. The method of claim 10, wherein the nanocrystalline cellulose, microcrystalline cellulose, cellulose fibrils, or bacterial nanocellulose have lengths between 50 nanometers and 3 millimeters.

15. The method of claim 10, wherein the slurry composition contains inorganic cement that comprises portland cement, calcium aluminate cement, fly ash, blast furnace slag, lime/silica blends or zeolites or combinations thereof.

16. A method for cementing a subterranean well, comprising:
(i) preparing a cement slurry, the slurry comprising water, an inorganic cement and an additive that comprises nanocrystalline cellulose, microcrystalline cellulose, cellulose fibrils, or bacterial nanocellulose or a combination thereof;
(ii) placing the slurry in the well.

17. The method of claim 16, wherein the cellulose fibrils are microfibrils or nanofibrils or both.

18. The method of claim 16, wherein the additive is present at a concentration between 0.001% and 5% by weight of the cement.

19. The method of claim 16, wherein the nanocrystalline cellulose, microcrystalline cellulose, cellulose fibrils, or bacterial nanocellulose have diameters between 4 nanometers and 20 microns.

20. The method of claim 16, wherein the nanocrystalline cellulose, microcrystalline cellulose, cellulose fibrils, or bacterial nanocellulose have lengths between 50 nanometers and 3 millimeters.

21. The method of claim 16, wherein the cement comprises portland cement, calcium aluminate cement, fly ash, blast furnace slag, lime/silica blends or zeolites or combinations thereof.

22. The method of claim 16, wherein the slurry placement occurs during a primary cementing operation or a remedial cementing operation.
